(19) United States
(12) Patent Application Publication
(10) Pub. No.: US 2025/0372036 A1
(43) Pub. Date: Dec. 4, 2025

(54) DISPLAY APPARATUS, METHOD OF DRIVING THE SAME AND ELECTRONIC APPARATUS INCLUDING THE SAME

(71) Applicant: Samsung Display Co., LTD., Yongin-si (KR)

(72) Inventors: HAE-KWAN SEO, Yongin-si (KR); HYOUNGWOOK JANG, Yongin-si (KR)

(21) Appl. No.: 19/068,367

(22) Filed: Mar. 3, 2025

(30) Foreign Application Priority Data
May 28, 2024 (KR) 10-2024-0068958

(51) Int. Cl. G09G 3/3233; G06V 40/13

(52) U.S. Cl. CPC G09G 3/3233; G06V 40/1318; G09G 2300/0819; G09G 2300/0842; G09G 2310/08; G09G 2354/00

(57) ABSTRACT

A display apparatus includes a display panel, a gate driver, a data driver and a sensing processor. The display panel includes a pixel circuit including a light emitting element and a light sensing circuit including a light sensing element. The gate driver outputs a gate signal to the pixel circuit and the light sensing circuit. The data driver outputs a data voltage to the pixel circuit. The sensing processor receives a sensed signal from the light sensing circuit. A horizontal period of a normal frame, in which the sensed signal is not sensed from the light sensing circuit, is different from a horizontal period of a sensing frame in which the sensed signal is sensed from the light sensing circuit.

This application claims priority to Korean Patent Application No. 10-2024-0068958, filed on May 28, 2024, and all the benefits accruing therefrom under 35 U.S.C. § 119, the content of which in its entirety is herein incorporated by reference.

### BACKGROUND

### 1. Field

Embodiments of the invention relate to a display apparatus, a method of driving the display apparatus, and an electronic apparatus including the display apparatus. More particularly, embodiments of the invention relate to a display apparatus including a display panel including a light sensing circuit, a method of driving the display apparatus, and an electronic apparatus including the display apparatus.

### 2. Description of the Related Art

Electronic apparatuses (e.g., a smart phone, a smart watch, etc.) have been developed which perform bio-sensing operations, e.g., a fingerprint sensing operation, a photoplethysmography (PPG) sensing operation, etc. These electronic apparatuses may perform the bio-sensing operations using a sensor that is separate from a display apparatus. In this case, the size of a display region of the electronic apparatus may be reduced, and the size of a bezel may be increased.

### SUMMARY

Attempts have been made for an electronic apparatus to provide bio-sensing operations without reducing the size of a display region of the electronic apparatus or increasing the size of a bezel. For example, an in-cell light sensor technique which employs an optical sensor or a light sensing pixel within the display region of the display apparatus may be used.

Embodiments of the invention provide a display apparatus reducing a sensing time by setting a horizontal period of a normal frame and a horizontal period of a sensing frame differently in the display apparatus including a display panel including a light sensing circuit.

Embodiments of the invention also provide a method of driving the display apparatus.

Embodiments of the invention also provide an electronic apparatus including the display apparatus.

In an embodiment of a display apparatus according to the invention, the display apparatus includes a display panel, a gate driver, a data driver and a sensing processor. In such an embodiment, the display panel includes a pixel circuit including a light emitting element and a light sensing circuit including a light sensing element. In such an embodiment, the gate driver outputs a gate signal to the pixel circuit and the light sensing circuit. In such an embodiment, the data driver outputs a data voltage to the pixel circuit. In such an embodiment, the sensing processor receives a sensed signal from the light sensing circuit. In such an embodiment, a horizontal period of a normal frame, in which the sensed signal is not sensed from the light sensing circuit, is different from a horizontal period of a sensing frame in which the sensed signal is sensed from the light sensing circuit.

In an embodiment, the horizontal period of the sensing frame may include a first horizontal period corresponding to a non-sensing area of the display panel and a second horizontal period corresponding to a sensing area of the display panel. In such an embodiment, the first horizontal period may be different from the second horizontal period.

In an embodiment, the second horizontal period may be longer than the first horizontal period.

In an embodiment, the second horizontal period may be longer than the horizontal period of the normal frame.

In an embodiment, when a total number of pixel rows of the display panel is denoted by M, a number of pixel rows in the sensing area is denoted by X, a length of the sensing frame is denoted by FRM, the second horizontal period is denoted by SH and the first horizontal period is denoted by NSH,

$$NSH = \frac{FRM - SH \times X}{M - X}$$

may be satisfied.

In an embodiment, a length of the sensing frame may be twice a length of the normal frame.

In an embodiment, the first horizontal period may be longer than the horizontal period of the normal frame.

In an embodiment, the first horizontal period may be shorter than twice the horizontal period of the normal frame.

In an embodiment, the non-sensing area and the sensing area may be sequentially disposed along a scanning direction of the gate signal, and a light emitting period of the non-sensing area may gradually decrease along the scanning direction in the sensing frame and a light emitting period of the sensing area may gradually decrease along the scanning direction in the sensing frame.

In an embodiment, a light emitting period of the non-sensing area may gradually increase along the scanning direction in an immediately previous frame of the sensing frame and a light emitting period of the sensing area may gradually increase along the scanning direction in the immediately previous frame of the sensing frame.

In an embodiment, a length of the sensing frame may be substantially the same as a length of the normal frame.

In an embodiment, the first horizontal period may be shorter than the horizontal period of the normal frame.

In an embodiment, the non-sensing area and the sensing area may be sequentially disposed along a scanning direction of the gate signal, and a light emitting period of the non-sensing area may gradually increase along the scanning direction in the sensing frame and a light emitting period of the sensing area may gradually decrease along the scanning direction in the sensing frame.

In an embodiment, a light emitting period of the non-sensing area may gradually decrease along the scanning direction in an immediately previous frame of the sensing frame and a light emitting period of the sensing area may gradually increase along the scanning direction in the immediately previous frame of the sensing frame.

In an embodiment, the light sensing circuit may further include an eighth transistor including a control electrode connected to a fourth node, a first electrode which receives a first voltage and a second electrode connected to a fifth node, a ninth transistor including a control electrode which receives a reset signal, a first electrode which receives a reset voltage and a second electrode connected to the fourth node and a tenth transistor including a control electrode which receives the gate signal, a first electrode connected to the fifth node and a second electrode connected to a sensing line. In such an embodiment, the light sensing element may include a first electrode connected to the fourth node and a second electrode which receives a second power voltage.

In an embodiment, the pixel circuit may further include a first transistor including a control electrode connected to a first node, a first electrode connected to a second node and a second electrode connected to a third node, a second transistor including a control electrode which receives the gate signal, a first electrode which receives the data voltage and a second electrode connected to the second node, a third transistor including a control electrode which receives a compensation gate signal, a first electrode connected to the first node and a second electrode connected to the third node, a fourth transistor including a control electrode which receives a data initialization gate signal, a first electrode which receives a first initialization voltage and a second electrode connected to the first node, a fifth transistor including a control electrode which receives an emission signal, a first electrode which receives a first power voltage and a second electrode connected to the second node, a sixth transistor including a control electrode which receives the emission signal, a first electrode connected to the third node and a second electrode connected to a first electrode of the light emitting element and a seventh transistor including a control electrode which receives a light emitting element initialization gate signal, a first electrode which receives a second initialization voltage and a second electrode connected to the first electrode of the light emitting element. In such an embodiment, a second electrode of the light emitting element may receive the second power voltage.

In an embodiment, the sensing processor may include an amplifier including a first input terminal connected to the sensing line, a second input terminal which receives a reference voltage and an output terminal, a first switch connected between the first input terminal of the amplifier and the output terminal of the amplifier, a first capacitor connected between the first input terminal of the amplifier and the output terminal of the amplifier, an analog-to-digital converter including a first input node and a second input node, a second switch connected between the output terminal of the amplifier and the first input node of the analog-to-digital converter and a third switch connected between the output terminal of the amplifier and the second input node of the analog-to-digital converter.

In an embodiment of a method of driving a display apparatus, the method includes outputting a gate signal to a pixel circuit including a light emitting element and a light sensing circuit including a light sensing element, outputting a data voltage to the pixel circuit and receiving a sensed signal from the light sensing circuit. In such an embodiment, a horizontal period of a normal frame, in which the sensed signal is not sensed from the light sensing circuit, is different from a horizontal period of a sensing frame in which the sensed signal is sensed from the light sensing circuit.

In an embodiment, the horizontal period of the sensing frame may include a first horizontal period corresponding to a non-sensing area of a display panel and a second horizontal period corresponding to a sensing area of the display panel. In such an embodiment, the first horizontal period may be different from the second horizontal period.

In an embodiment, when a total number of pixel rows of the display panel is denoted by M, a number of pixel rows in the sensing area is denoted by X, a length of the sensing frame is denoted by FRM, the second horizontal period is denoted by SH and the first horizontal period is denoted by NSH,

$$NSH = \frac{FRM - SH \times X}{M - X}$$

may be satisfied.

In an embodiment of an electronic apparatus according to the invention, the electronic apparatus includes a display panel, a gate driver, a data driver, a sensing processor, a driving controller and a processor. In such an embodiment, the display panel includes a pixel circuit including a light emitting element and a light sensing circuit including a light sensing element. In such an embodiment, the gate driver outputs a gate signal to the pixel circuit and the light sensing circuit. In such an embodiment, the data driver outputs a data voltage to the pixel circuit. In such an embodiment, the sensing processor receives a sensed signal from the light sensing circuit. In such an embodiment, the driving controller controls the gate driver, the data driver and the sensing processor. In such an embodiment, the processor outputs input image data and an input control signal to the driving controller. In such an embodiment, a horizontal period of a normal frame, in which the sensed signal is not sensed from the light sensing circuit, is different from a horizontal period of a sensing frame in which the sensed signal is sensed from the light sensing circuit.

According to embodiments of the display apparatus, the method of driving the display apparatus and the electronic apparatus including the display apparatus, the sensing time may be reduced by setting the horizontal period of the normal frame and the horizontal period of the sensing frame differently in the display apparatus including the display panel including the light sensing circuit.

In such embodiments, the length of the sensing frame may be set to twice the length of the normal frame and the first horizontal period of the sending frame corresponding to the non-sensing area and the second horizontal period of the sensing frame corresponding to the sensing area may be appropriately set such that the sensing operation may be completed within twice the time of the normal frame.

In such embodiments, the length of the sensing frame may be set substantially the same as the length of the normal frame and the first horizontal period of the sending frame corresponding to the non-sensing area and the second horizontal period of the sensing frame corresponding to the sensing area may be appropriately set such that the sensing operation may be completed within substantially the same time as the normal frame.

### BRIEF DESCRIPTION OF THE DRAWINGS

The above and other features of embodiments of the invention will become more apparent by describing in detailed embodiments thereof with reference to the accompanying drawings, in which:

FIG. 1 is a block diagram illustrating a display apparatus according to an embodiment of the invention;

FIG. 2 is a diagram illustrating a display panel of FIG. 1;

FIG. 3 is a diagram illustrating a sensed image through a sensing area of FIG. 2;

FIG. 4 is a circuit diagram illustrating an example of a portion of a display panel;

FIG. 5 is a signal timing diagram illustrating an example of input signals applied to a pixel circuit of FIG. 4;

FIG. 6 is a signal timing diagram illustrating an example of input signals applied to a pixel circuit of FIG. 4;

FIG. 7 is a circuit diagram illustrating a sensing processor of FIG. 1;

FIG. 8 is a diagram illustrating operation timings of a sensing circuit of the display panel of FIG. 1 and the sensing processor of FIG. 1;

FIG. 9 is a signal timing diagram illustrating an example of input signals applied to the sensing processor of FIG. 7;

FIG. 10 is a diagram illustrating a sensing operation of the display apparatus of FIG. 1 when a length of a sensing frame is twice a length of a normal frame;

FIG. 11 is a diagram illustrating the display panel of FIG. 1 including a first area, a second area and a third area;

FIG. 12 is a diagram illustrating a driving timing of the display apparatus of FIG. 1 when the length of the sensing frame is twice the length of the normal frame;

FIG. 13A is a diagram illustrating a horizontal period of the normal frame of FIG. 12;

FIG. 13B is a diagram illustrating a horizontal period of the sensing frame of FIG. 12;

FIG. 14 is a diagram illustrating a sensing operation of the display apparatus of FIG. 1 when the length of the sensing frame is substantially the same as the length of the normal frame;

FIG. 15 is a diagram illustrating a driving timing of the display apparatus of FIG. 1 when the length of the sensing frame is substantially the same as the length of the normal frame;

FIG. 16A is a diagram illustrating a horizontal period of the normal frame of FIG. 15;

FIG. 16B is a diagram illustrating a horizontal period of the sensing frame of FIG. 15;

FIG. 17 is a block diagram illustrating an electronic apparatus according to an embodiment of the invention; and

FIG. 18 is a diagram illustrating an example in which the electronic apparatus of FIG. 17 is implemented as a smart phone.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within +30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the invention will be described in detail with reference to the accompanying drawings.

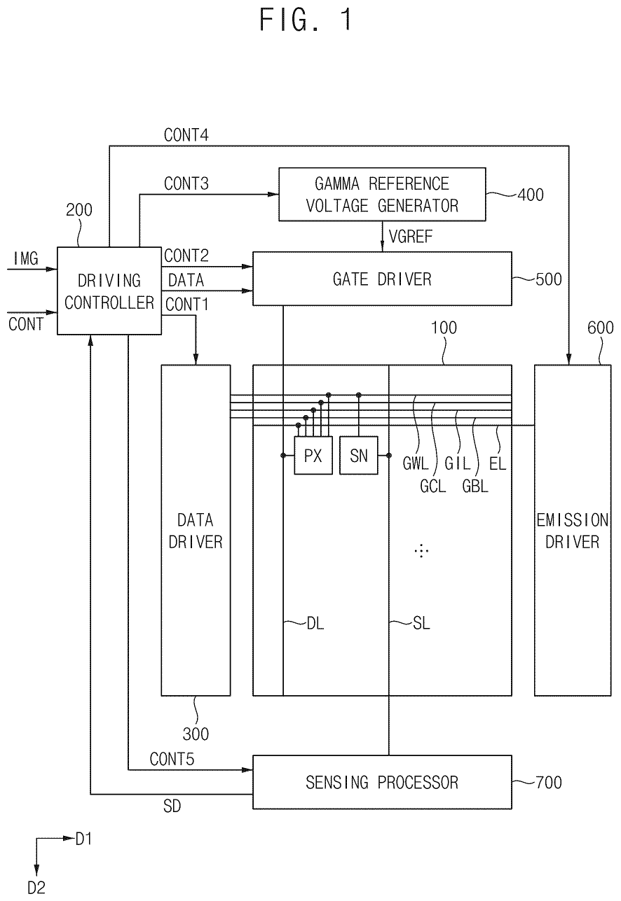

FIG. 1 is a block diagram illustrating a display apparatus according to an embodiment of the invention.

Referring to FIG. 1, an embodiment of the display apparatus includes a display panel 100 and a display panel driver. The display panel driver includes a driving controller 200, a gate driver 300, a gamma reference voltage generator 400, a data driver 500 and an emission driver 600. The display apparatus may further include a sensing processor 700.

The display panel 100 includes a pixel circuit PX including a light emitting element and a light sensing circuit SN including a light sensing element. The gate driver 300 may apply a gate signal to the pixel circuit and the light sensing circuit SN. The data driver 500 may output a data voltage to the pixel circuit PX. The sensing processor 700 may receive a sensed signal from the light sensing circuit SN.

In an embodiment, for example, the light emitting element may be a light emitting diode. In an embodiment, for example, the light emitting element may be an organic light emitting diode. In an embodiment, for example, the light emitting element may be a quantum dot light emitting diode. In an embodiment, for example, the light sensing element may be a photo diode. In an embodiment, for example, the light sensing element may be an organic photo diode.

The display panel 100 has a display region on which an image is displayed and a peripheral region adjacent to the display region.

The display panel 100 includes a plurality of gate lines GWL, GCL, GIL and GBL, a plurality of data lines DL, a plurality of emission lines EL and a plurality of pixels electrically connected to the gate lines GWL, GCL, GIL and GBL, the data lines DL and the emission lines EL. The gate lines GWL, GCL, GIL and GBL may extend in a first direction D1, the data lines DL may extend in a second direction D2 crossing the first direction D1 and the emission lines EL may extend in the first direction D1.

The display panel 100 may include a plurality of light sensing circuits SN connected to the gate lines (e.g., GWL) and sensing lines SL. The sensing lines SL may extend in the second direction D2.

The driving controller 200 receives input image data IMG and an input control signal CONT from an external apparatus (e.g., an application processor or a central processing unit). In an embodiment, for example, the input image data IMG may include red image data, green image data and blue image data. The input image data IMG may include white image data. The input image data IMG may include magenta image data, cyan image data and yellow image data. The input control signal CONT may include a master clock signal and a data enable signal. The input control signal CONT may further include a vertical synchronizing signal and a horizontal synchronizing signal. The input control signal CONT may further include a fingerprint sensing start signal.

The driving controller 200 may generate a first control signal CONT1, a second control signal CONT2, a third control signal CONT3, a fourth control signal CONT4, a fifth control signal CONT5 and a data signal DATA based on the input image data IMG and the input control signal CONT.

The driving controller 200 may generate the first control signal CONT1 for controlling an operation of the gate driver 300 based on the input control signal CONT, and output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT, and output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and output the third control signal CONT3 to the gamma reference voltage generator 400.

The driving controller 200 may generate the fourth control signal CONT4 for controlling an operation of the emission driver 600 based on the input control signal CONT, and output the fourth control signal CONT4 to the emission driver 600.

The driving controller 200 may generate the fifth control signal CONT5 for controlling an operation of the sensing processor 700 based on the input control signal CONT, and output the fifth control signal CONT5 to the sensing processor 700.

The gate driver 300 may generate gate signals driving the gate lines GWL, GCL, GIL and GBL in response to the first control signal CONT1 received from the driving controller 200. The gate driver 300 may output the gate signals to the gate lines GWL, GCL, GIL and GBL. In an embodiment, for example, the gate driver 300 may be integrated on the display panel 100. In an embodiment, for example, the gate driver 300 may be mounted on the display panel 100.

The gamma reference voltage generator 400 may generate a gamma reference voltage VGREF in response to the third control signal CONT3 received from the driving controller 200. The gamma reference voltage generator 400 may provide the gamma reference voltage VGREF to the data driver 500. The gamma reference voltage VGREF may have a value corresponding to a level of the data signal DATA.

In an embodiment, the gamma reference voltage generator 400 may be disposed in the driving controller 200, or in the data driver 500.

The data driver 500 may receive the second control signal CONT2 and the data signal DATA from the driving controller 200, and receive the gamma reference voltages VGREF from the gamma reference voltage generator 400. The data driver 500 may convert the data signal DATA into data voltages having an analog type using the gamma reference voltages VGREF. The data driver 500 may output the data voltages to the data lines DL.

The emission driver 600 may generate emission signals to drive the emission lines EL in response to the fourth control signal CONT4 received from the driving controller 200. The emission driver 600 may output the emission signals to the emission lines EL.

Although an embodiment where the gate driver 300 is disposed at a first side of the display panel 100 and the emission driver 600 is disposed at a second side of the display panel 100 opposite to the first side is shown in FIG. 1 for convenience of illustration and description, the invention may not be limited thereto. In an embodiment, for example, both of the gate driver 300 and the emission driver 600 may be disposed at the first side of the display panel 100. In an embodiment, for example, both of the gate driver 300 and the emission driver 600 may be disposed at both of the first side and the second side of the display panel 100. In an embodiment, for example, the gate driver 300 and the emission driver 600 may be integrally formed.

The sensing processor 700 may operate a sensing operation in response to the fifth control signal CONT5 received from the driving controller 200. The sensing processor 700 may output sensed data SD to the driving controller 200 in response to the fifth control signal CONT5.

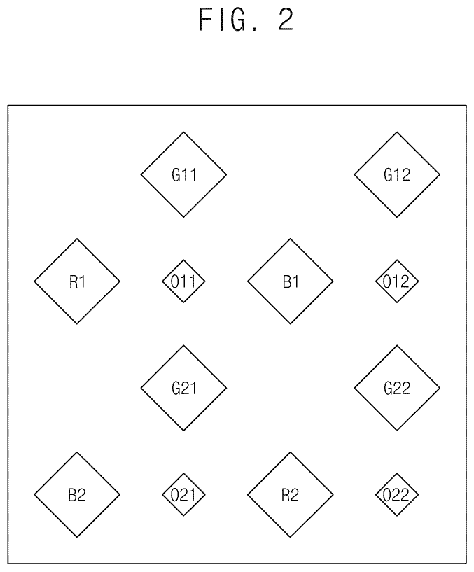

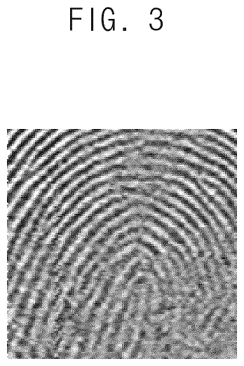

FIG. 2 is a diagram illustrating the display panel 100 of FIG. 1. FIG. 3 is a diagram illustrating a sensed image through a sensing area O11, O12, O13 and O14 of FIG. 2.

Referring to FIGS. 1 to 3, an embodiment of the display panel 100 may include the pixel circuit PX including the light emitting element and the light sensing circuit SN including the light sensing element.

In an embodiment, as shown in FIG. 2, the display panel 100 may include light emitting areas R1, B1, G11, G12, B2, R2, G21 and G22 connected to the pixel circuits PX and emitting a light. The display panel 100 may include a first green light emitting area G11 and a second green light emitting area G12 disposed in a first first row. The display panel 100 may further include a first red light emitting area R1 and a first blue light emitting area B1 disposed in a second first row. The display panel 100 may further include a third green light emitting area G21 and a fourth green light emitting area G22 disposed in a first second row. The display panel 100 may further include a second blue light emitting area B2 and a second red light emitting area R2 disposed in a second second row.

The first red light emitting area R1, the first green light emitting area G11, the first blue light emitting area B1 and the third green light emitting area G21 may be disposed in a diamond shape.

In an embodiment, as shown in FIG. 2, the display panel 100 may include sensing areas O11, O12, O13 and O14 connected to the light sensing circuits SN and sensing a light.

First sensing area O11 and a second sensing area O12 are disposed adjacent to each other in the first direction D1. Third sensing area O13 and a fourth sensing area O14 are disposed adjacent to each other in the first direction D1.

The first sensing area O11 and the third sensing area O21 are disposed adjacent to each other in the second direction D2. The second sensing area O12 and the fourth sensing area O14 are disposed adjacent to each other in the second direction D2.

The first sensing area O11 and the second sensing area O12 may be disposed in the second first row. The third sensing area O13 and the fourth sensing area O14 may be disposed in the second second row.

The first sensing area O11 may be disposed between the first red light emitting area R1 and the first blue light emitting area B1. The third sensing area O21 may be disposed between the second red light emitting area R2 and the second blue light emitting area B2.

FIG. 2 represents a portion of the display panel 100. The portion of the display panel 100 illustrated in FIG. 2 may be repeated in the first direction D1 and the second direction D2.

FIG. 3 represents an example of an image generated by sensing a human's fingerprint through the sensing area O11, O12, O13 and O14.

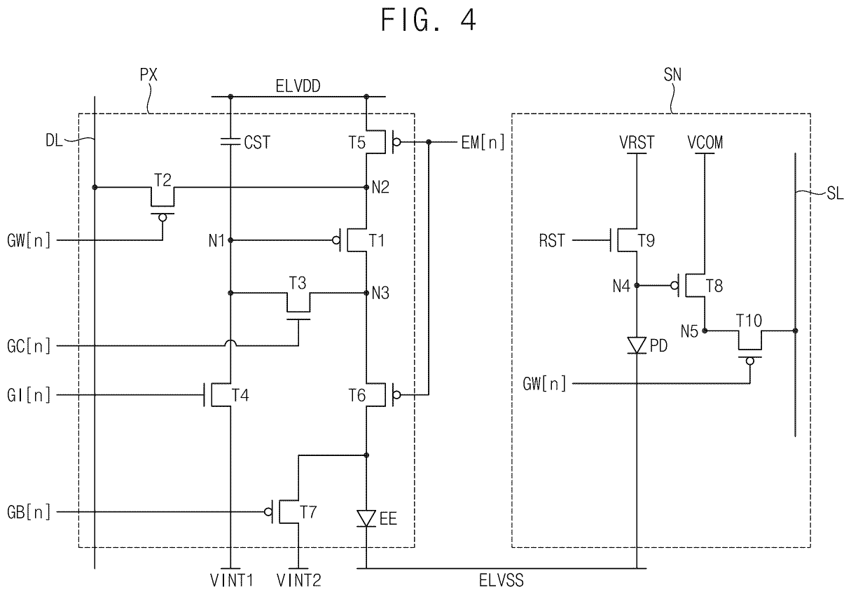

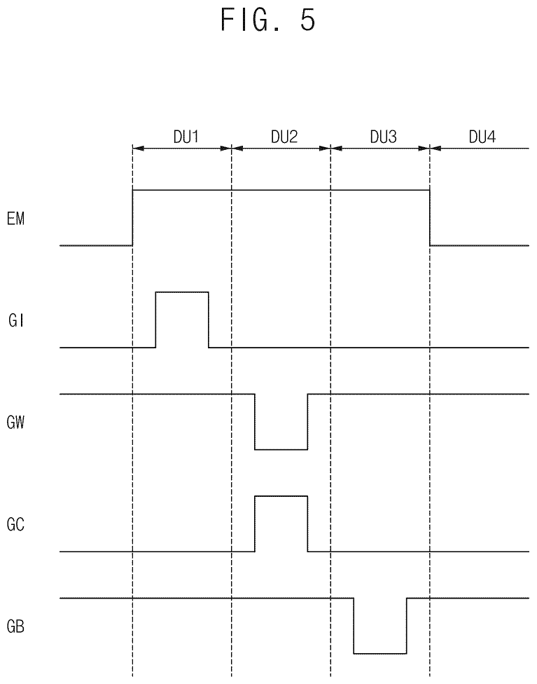

FIG. 4 is a circuit diagram illustrating an example of a portion of the display panel 100. FIG. 5 is a signal timing diagram illustrating an example of input signals applied to the pixel circuit PX of FIG. 4.

Referring to FIGS. 1 to 5, an embodiment of the display panel 100 includes a plurality of pixel circuits PX. Each of the pixel circuits PX may include a light emitting element EE.

The pixels may receive a gate signal GW, a compensation gate signal GC, an initialization gate signal GI, a light emitting element initialization gate signal GB, the data voltage VDATA and the emission signal EM and the light emitting elements EE of the pixels may emit a light corresponding to a level of the data voltage VDATA to display an image.

At least one of the pixels may include first to seventh transistors T1 to T7, a storage capacitor CST and the light emitting element EE.

The first transistor T1 includes a control electrode connected to a first node N1, a first electrode connected to a second node N2 and a second electrode connected to a third node N3.

The second transistor T2 includes a control electrode that receives the gate signal GW, a first electrode that receives the data voltage VDATA and a second electrode connected to the second node N2.

The third transistor T3 includes a control electrode that receives the compensation gate signal GC, a first electrode connected to the first node N1 and a second electrode connected to the third node N3.

The fourth transistor T4 includes a control electrode that receives the data initialization gate signal GI, a first electrode that receives a first initialization voltage VINT1 and a second electrode connected to the first node N1.

The fifth transistor T5 includes a control electrode that receives the emission signal EM, a first electrode that receives a first power voltage ELVDD and a second electrode connected to the second node N2.

The sixth transistor T6 includes a control electrode that receives the emission signal EM, a first electrode connected to the third node N3 and a second electrode connected to a first electrode of the light emitting element EE.

The seventh transistor T7 includes a control electrode that receives the light emitting element initialization gate signal GB, a first electrode that receives a second initialization voltage VINT2 and a second electrode connected to the first electrode of the light emitting element EE.

In an embodiment, the first initialization voltage VINT1 may be different from the second initialization voltage VINT2. Alternatively, the first initialization voltage VINT1 may be substantially the same as the second initialization voltage VINT2.

The storage capacitor CST includes a first electrode that receives the first power voltage ELVDD and a second electrode connected to the first node N1.

The light emitting element EE includes the first electrode and a second electrode that receives a second power voltage ELVSS.

In an embodiment, for example, the first transistor T1, the second transistor T2, the fifth transistor T5, the sixth transistor T6 and the seventh transistor T7 may be P-type transistors. For example, the first transistor T1, the second transistor T2, the fifth transistor T5, the sixth transistor T6 and the seventh transistor T7 may be poly silicon transistors. In an embodiment, for example, the first transistor T1, the second transistor T2, the fifth transistor T5, the sixth transistor T6 and the seventh transistor T7 may be low temperature poly silicon transistors (LTPS).

In an embodiment, for example, the third transistor T3 and the fourth transistor T4 may be N-type transistors. In an embodiment, for example, the third transistor T3 and the fourth transistor T4 may be oxide semiconductor transistors.

In FIG. 4, [n] represents a signal applied to an n-th pixel row. That is, FIG. 4 shows a pixel PX that receives an n-th gate signal GW[n], an n-th compensation gate signal GC [n], an n-th initialization gate signal GI [n], an n-th light emitting element initialization gate signal GB[n], and an n-th emission signal EM [n], where n is a natural number for convenience of illustration. The gate signal GW[n], the compensation gate signal GC [n], the data initialization gate signal GI [n], the light emitting element initialization gate signal GB[n] and the emission signal EM [n] may be progressive signals applied to the pixel rows progressively.

The light sensing circuit SN may further include an eighth transistor T8 including a control electrode connected to a fourth node N4, a first electrode that receives a first voltage VCOM and a second electrode connected to a fifth node N5, a ninth transistor T9 including a control electrode that receives a reset signal RST, a first electrode that receives a reset voltage VRST and a second electrode connected to the fourth node N4 and a tenth transistor T10 including a control electrode that receives the gate signal GW, a first electrode connected to the fifth node N5 and a second electrode connected to the sensing line SL.

The light sensing element PD may include a first electrode connected to the fourth node N4 and a second electrode that receives the second power voltage ELVSS.

In an embodiment, for example, the eighth transistor T8 and the tenth transistor T10 may P-type transistors. In an embodiment, for example, the eighth transistor T8 and the tenth transistor T10 may poly silicon transistors. In an embodiment, for example, the eighth transistor T8 and the tenth transistor T10 may be low temperature poly silicon transistors (LTPS).

In an embodiment, for example, the ninth transistor may be an N-type transistor. In an embodiment, for example, the ninth transistor may be an oxide semiconductor transistor.

In an embodiment, as shown in FIG. 5, during a first duration DU1, the first node N1 and the storage capacitor CST are initialized in response to the data initialization gate signal GI. During a second duration DU2, a threshold voltage (|VTH|) of the first transistor T1 is compensated and the data voltage VDATA of which the threshold voltage (|VTH|) is compensated is written to the first node N1 in response to the gate signal GW and the compensation gate signal GC. During a third duration DU3, the first electrode of the light emitting element EE is initialized in response to the light emitting element initialization gate signal GB. During a fourth duration DU4, the light emitting element EE emits a light in response to the emission signal EM so that the display panel 100 displays the image.

During the first duration DU1, the data initialization gate signal GI may have an active level. In an embodiment, for example, the active level of the data initialization gate signal GI may be a high level. When the data initialization gate signal GI has the active level, the fourth transistor T4 is turned on such that the first initialization voltage VINT1 may be applied to the first node N1.

During the second duration DU2, the gate signal GW and the compensation gate signal GC may have active levels. In an embodiment, for example, the active level of the gate signal GW may be a low level. In an embodiment, for example, the active level of the compensation gate signal GC may be a high level. When the gate signal GW has the active level, the second transistor T2 is turned on. When the compensation gate signal GC has the active level, the third transistor T3 is turned on. In addition, the first transistor T1 is turned on in response to the first initialization voltage VINT1.

A voltage, which is subtraction of an absolute value of the threshold voltage (|VTH|) of the first transistor T1 from the data voltage VDATA, may be charged at the first node N1 along a path generated by the first to third transistors T1, T2 and T3.

During the third duration DU3, the light emitting element initialization gate signal GB may have an active level. In an embodiment, for example, the active level of the light emitting element initialization gate signal GB may be a low level. When the light emitting element initialization gate signal GB has the active level, the seventh transistor T7 is turned on so that the second initialization voltage VINT2 may be applied to the first electrode of the light emitting element EE. In an embodiment, for example, the light emitting element initialization gate signal GB[n] of a present stage may be a gate signal GW[n+1] of a next stage.

During the fourth duration DU4, the emission signal EM may have an active level. The active level of the emission signal EM may be a low level. When the emission signal EM has the active level, the fifth transistor T5 and the sixth transistor T6 are turned on. In addition, the first transistor T1 is turned on by the data voltage VDATA.

A driving current sequentially flows through the fifth transistor T5, the first transistor T1 and the sixth transistor T6 to drive the light emitting element EE. An intensity of the driving current may be determined by the level of the data voltage VDATA. A luminance of the light emitting element EE is determined by the intensity of the driving current.

The threshold voltage (|VTH|) is compensated during the second duration DU2, so that the driving current may be determined regardless of the threshold voltage (|VTH|) of the first transistor T1 when the light emitting element EE emits the light during the fourth duration DU4.

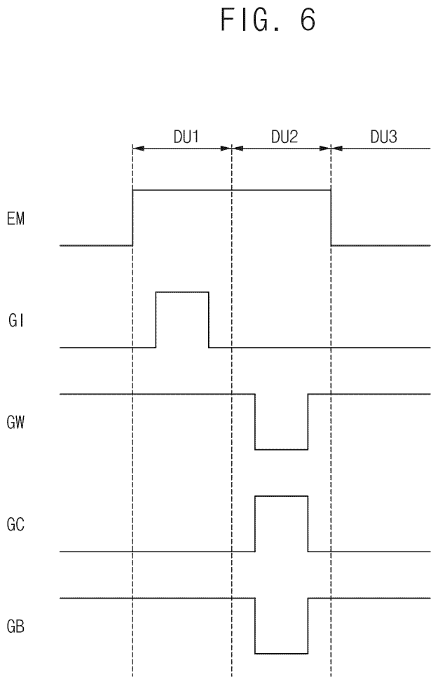

FIG. 6 is a signal timing diagram illustrating an example of input signals applied to a pixel circuit of FIG. 4.

The input signals applied to the pixel of the display apparatus and the method of driving the display apparatus of FIG. 6 are substantially the same as the input signals applied to the pixel of the display apparatus and the method of driving the display apparatus of FIGS. 1 to 5 except that the active period of the light emitting element initialization gate signal GB is the same as the active period of the gate signal GW. Thus, the same reference numerals will be used to refer to the same or like parts as those described above with reference to FIGS. 1 to 5 and any repetitive detailed description thereof will be omitted.

Referring to FIGS. 1 to 4 and 6, in an embodiment, during a first duration DU1, the first node N1 and the storage capacitor CST are initialized in response to the data initialization gate signal GI. During a second duration DU2, a threshold voltage (|VTH|) of the first transistor T1 is compensated and the data voltage VDATA of which the threshold voltage (|VTH|) is compensated is written to the first node N1 in response to the gate signal GW and the compensation gate signal GC. In addition, during the second duration DU2, the first electrode of the light emitting element EE is initialized in response to the light emitting element initialization gate signal GB. During a third duration DU3, the light emitting element EE emits the light in response to the emission signal EM such that the display panel 100 displays the image.

In such an embodiment, the active period of the light emitting element initialization gate signal GB may be substantially the same as the active period of the gate signal GW. In an embodiment, for example, the control electrode of the seventh transistor T7 may be connected to the control electrode of the second transistor T2.

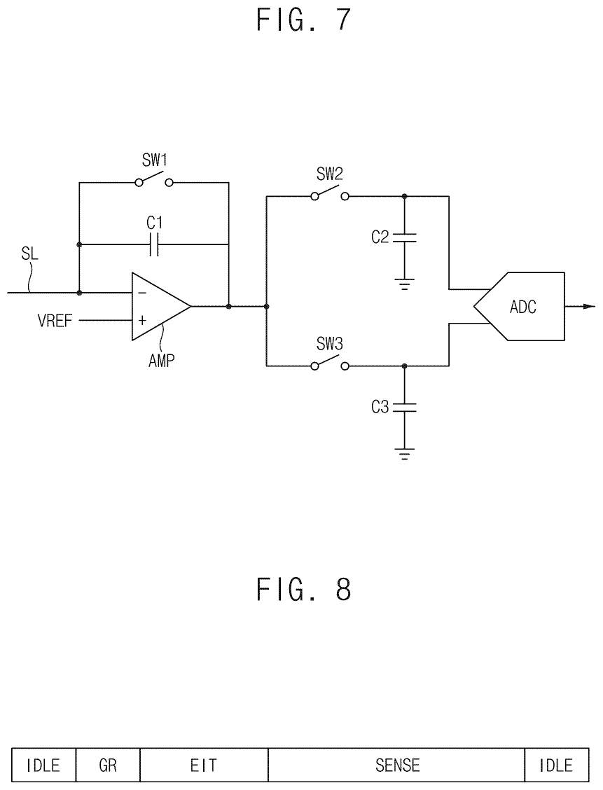

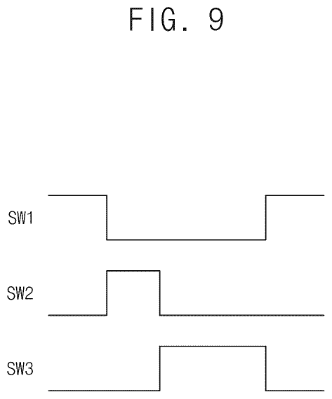

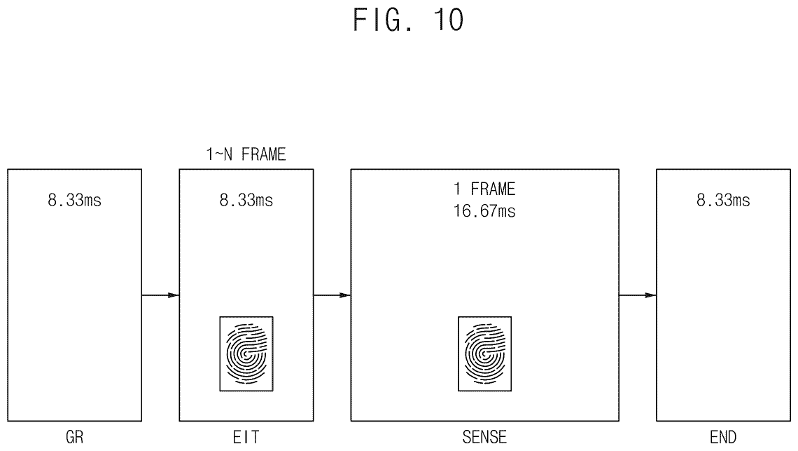

FIG. 7 is a circuit diagram illustrating the sensing processor 700 of FIG. 1. FIG. 8 is a diagram illustrating operation timings of a sensing circuit SN of the display panel 100 of FIG. 1 and the sensing processor 700 of FIG. 1. FIG. 9 is a signal timing diagram illustrating an example of input signals applied to the sensing processor 700 of FIG. 7.

Referring to FIGS. 1 to 9, an embodiment of the sensing processor 700 may include an amplifier AMP including a first input terminal connected to the sensing line SL, a second input terminal that receives a reference voltage VREF and an output terminal, a first switch SW1 connected between the first input terminal of the amplifier AMP and the output terminal of the amplifier AMP, a first capacitor C1 connected between the first input terminal of the amplifier AMP and the output terminal of the amplifier AMP, an analog-to-digital converter ADC including a first input node and a second input node, a second switch SW2 connected between the output terminal of the amplifier AMP and the first input node of the analog-to-digital converter ADC and a third switch SW3 connected between the output terminal of the amplifier AMP and the second input node of the analog-to-digital converter ADC.

The sensing processor 700 may further include a second capacitor C2 connected to the first input node of the analog-to-digital converter ADC and a third capacitor C3 connected to the second input node of the analog-to-digital converter ADC.

The analog-to-digital converter ADC of the sensing processor 700 may be connected a single sensing line SL. The single sensing line SL may be commonly connected to the plural sensing circuits SN disposed in a pixel column direction. The analog-to-digital converter ADC may receive a sensed signal from the light sensing circuit SN disposed in a pixel row in which the gate signal GW is activated.

In an embodiment, as shown in FIG. 8, the light sensing circuit SN may be in an idle status IDLE before the fingerprint sensing start signal is inputted to the driving controller 200.

When the fingerprint sensing start signal is inputted to the driving controller 200, a reset operation GR of the light sensing circuit SN may be performed. Herein, the control electrode of the ninth transistor T9 may be applied to the reset signal RST.

Subsequent to the reset operation GR, a fingerprint image output operation EIT, in which a fingerprint image is displayed in a predetermined area (the sensing area) of the display panel 100, may be performed.

Subsequent to the fingerprint image output operation EIT, a sensing operation SENSE may be performed. Herein, the gate signal GW may be applied to the control electrode of the tenth transistor T10 and the sensed signal of the light sensing element PD may be outputted through the sensing line SL.

As shown in FIG. 9, in a first period, a control signal of the first switch SW1 has an active level, a control signal of the second switch SW2 has an inactive level and a control signal of the third switch SW3 has an inactive level.

In a second period, the control signal of the first switch SW1 has an inactive level, the control signal of the second switch SW2 has an active level and the control signal of the third switch SW3 has the inactive level.

In a third period, the control signal of the first switch SW1 has the inactive level, the control signal of the second switch SW2 has the inactive level and the control signal of the third switch SW3 has an active level.

In an embodiment, for example, the active levels of the control signal of the first switch SW1, the control signal of the second switch SW2 and the control signal of the third switch SW3 may be high levels and the inactive levels of the control signal of the first switch SW1, the control signal of the second switch SW2 and the control signal of the third switch SW3 may be low levels.

The first period may correspond to the status of IDLE of the light sensing circuit SN. The second period and the third period may correspond to the sensing operation SENSE of the light sensing circuit SN.

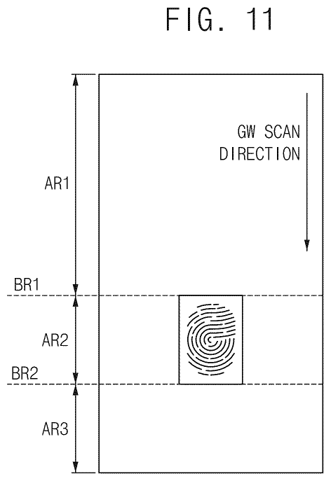

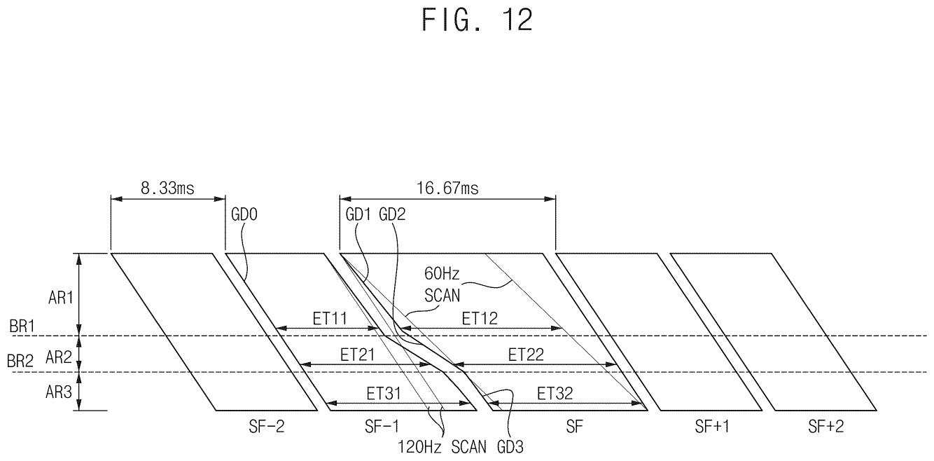

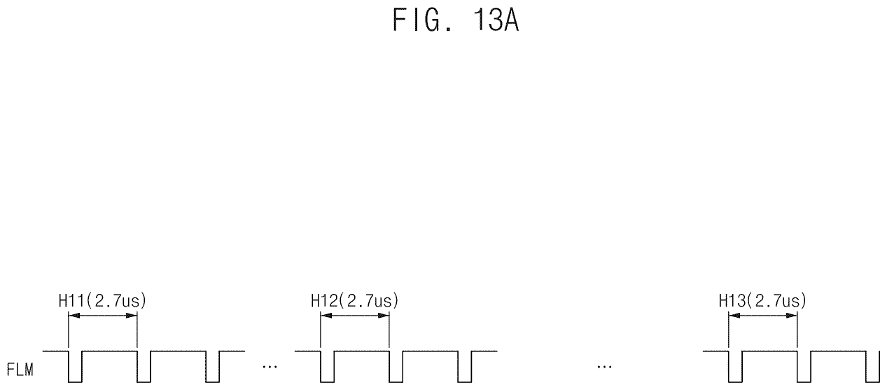

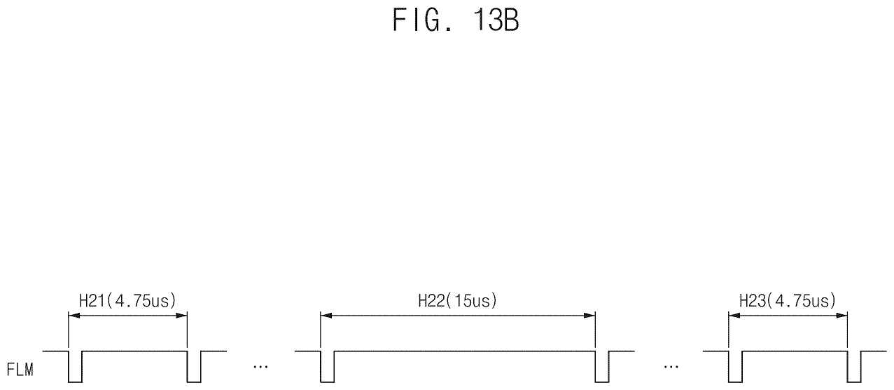

FIG. 10 is a diagram illustrating the sensing operation of the display apparatus of FIG. 1 when a length of a sensing frame is twice a length of a normal frame. FIG. 11 is a diagram illustrating the display panel 100 of FIG. 1 including a first area, a second area and a third area. FIG. 12 is a diagram illustrating a driving timing of the display apparatus of FIG. 1 when the length of the sensing frame is twice the length of the normal frame. FIG. 13A is a diagram illustrating a horizontal period of the normal frame of FIG. 12. FIG. 13B is a diagram illustrating a horizontal period of the sensing frame of FIG. 12.

Referring to FIGS. 1 to 13B, in an embodiment, for example, a driving frequency of the display panel 100 may be 120 hertz (Hz), and accordingly, the length of the normal frame may be about 8.33 milliseconds (ms) in FIG. 10. However, the invention may not be limited to the driving frequency of the display panel 100.

GR in FIG. 10 may mean the reset operation GR of FIG. 8. In an embodiment, as shown in FIG. 10, all of the light sensing circuits SN of the display panel 100 may be reset in a single frame. In another embodiment, the reset operation GR may continue (be continuously performed) for two or more frames. In such an embodiment, all of the light sensing circuits SN of the display panel 100 may be reset in two or more frames.

EIT in FIG. 10 may mean the fingerprint image output operation EIT of FIG. 8. The fingerprint image may be displayed on the display panel 100 for first to N-th frames.

SENSE in FIG. 10 may mean the sensing operation SENSE of FIG. 8. In an embodiment, the length of the sensing frame in which the sensed signal is sensed from the light sensing circuit SN may be twice the length of the normal frame, in which the sensed signal is not sensed from the light sensing circuit SN. In an embodiment, for example, the length of the normal frame may be about 8.33 ms and the length of the sensing frame may be about 16.67 ms.

END in FIG. 10 may mean a next frame of a frame in which the sensing operation SENSE is terminated.

The horizontal period of the normal frame may be different from the horizontal period of the sensing frame.

The horizontal period of the normal frame may be calculated by dividing the length of the normal frame by the number of pixel rows of the display panel 100. When the length of the normal frame is about 8.33 ms and a total number of the pixel rows of the display panel 100 is 3080, the horizontal period of the normal frame may be about 2.7 microseconds (us or μs).

The display panel 100 may include a non-sensing area AR1 and a sensing area AR2. In an embodiment, for example, the sensed signal may be received from the light sensing circuit SN in the sensing area AR2. In an embodiment, for example, the fingerprint image may be displayed in the sensing area AR2.

In an embodiment, as shown in FIG. 11, the display panel 100 may include the non-sensing area AR1, the sensing area AR2 and a second non-sensing area AR3 which are sequentially disposed along a scanning direction of the gate signal GW. A boundary between the non-sensing area AR1 and the sensing area AR2 may be a first boundary BR1 and a boundary between the sensing area AR2 and the second non-sensing area AR3 may be a second boundary BR2.

In an embodiment, for example, the horizontal period of the sensing frame may include a first horizontal period corresponding to the non-sensing area AR1 of the display panel 100 and a second horizontal period corresponding to the sensing area AR2 of the display panel 100. The first horizontal period may be different from the second horizontal period.

The second horizontal period may be a time used for the light sensing circuit SN to sense a light and transmit the sensed signal to the analog-to-digital converter ADC and for the analog-to-digital converter ADC to convert the sensed signal into a digital value.

In an embodiment, for example, the second horizontal period may be longer than the first horizontal period. The second horizontal period may be longer than the horizontal period (e.g., about 2.7 μs) of the normal frame. The second horizontal period may be about 12 us to about 15 μs.

When the total number of the pixel rows of the display panel 100 is denoted by M, a number of pixel rows in the sensing area AR2 is denoted by X, the length of the sensing frame is FRM, the second horizontal period is denoted by SH and the first horizontal period is denoted by NSH, the following equation:

$$NSH = \frac{FRM - SH \times X}{M - X}$$

may be satisfied.

In an embodiment for example, where the total number M of the pixel rows is 3080, the number of the pixel rows in the sensing area AR2 is 200, the length FRM of the sensing frame is about 16.67 ms and the second horizontal period SH is about 15 μs, the first horizontal period NSH may be about 4.75 μs.

In an embodiment, the first horizontal period (e.g., about 4.75 μs) may be longer than the horizontal period (e.g., about 2.7 μs) of the normal frame. In an embodiment, the first horizontal period (e.g., about 4.75 μs) may be shorter than twice (e.g., about 5.4 μs) the horizontal period of the normal frame.

In FIG. 12, SF may be the sensing frame and SF−1 may be a frame immediately prior to the sensing frame SF. In FIG. 12, SF−2, SF+1 and SF+2 may be normal frames.

In FIG. 12, the horizontal period (e.g., about 2.7 μs) of the normal frame may be represented as a slope of GD0. In FIG. 12, the first horizontal period (e.g., about 4.75 μs) corresponding to the non-sensing area AR1 of the sensing frame may be represented as a slope of GD1. In FIG. 12, a third horizontal period (e.g., about 4.75 μs) corresponding to the second non-sensing area AR3 of the sensing frame may be represented as a slope of GD3.

In FIG. 12, the slope of GD1 (corresponding to the horizontal period of about 4.75 μs) may be less than a slope (corresponding to a horizontal period of about 2.7 μs) of a scan timing of 120 Hz and may be greater than a slope (corresponding to a horizontal period of about 5.4 μs) of a scan timing of 60 Hz.

FIG. 13A illustrates the horizontal period H11 (e.g., about 2.7 μs) corresponding to the non-sensing area AR1 of the normal frame, the horizontal period H12 (e.g. about 2.7 μs) corresponding to the sensing area AR2 of the normal frame and the horizontal period H13 (e.g. about 2.7 μs) corresponding to the second non-sensing area AR3 of the normal frame.

FIG. 13B illustrates the horizontal period H21 (e.g. about 4.75 μs) corresponding to the non-sensing area AR1 of the sensing frame SF, the horizontal period H22 (e.g. about 15 μs) corresponding to the sensing area AR2 of the sensing frame SF and the horizontal period H23 (e.g. about 4.75 μs) corresponding to the second non-sensing area AR3 of the sensing frame SF.

Referring back to FIG. 12, in an embodiment where the non-sensing area AR1 and the sensing area AR2 are sequentially disposed along the scanning direction of the gate signal GW, a light emitting period ET12 of the non-sensing area AR1 may gradually decrease along the scanning direction in the sensing frame SF and a light emitting period ET22 of the sensing area AR2 may gradually decrease along the scanning direction in the sensing frame SF. In such an embodiment, a light emitting period ET32 of the second non-sensing area AR3 may gradually decrease along the scanning direction in the sensing frame SF.

A light emitting period of an immediately previous frame SF−1 of the sensing frame SF may be determined in relation to a light emitting period of the sensing frame SF. Thus, in an embodiment where the non-sensing area AR1 and the sensing area AR2 are sequentially disposed along the scanning direction of the gate signal GW, a light emitting period ET11 of the non-sensing area AR1 may gradually increase along the scanning direction in the immediately previous frame SF−1 of the sensing frame SF and a light emitting period ET21 of the sensing area AR2 may gradually increase along the scanning direction in the immediately previous frame SF−1 of the sensing frame SF. In such an embodiment, a light emitting period ET31 of the second non-sensing area AR3 may gradually increase along the scanning direction in the immediately previous frame SF−1 of the sensing frame SF.

In an embodiment of the invention, a luminance difference due to a difference of the light emitting period ET12, ET22 and ET32 between the non-sensing area AR1, the sensing area AR2 and the second non-sensing area AR3 in the sensing frame SF may be compensated by the driving controller 200.

In an embodiment of the invention, a luminance difference due to a difference of the light emitting period ET11, ET21 and ET31 between the non-sensing area AR1, the sensing area AR2 and the second non-sensing area AR3 in the immediately previous frame SF−1 of the sensing frame SF may be compensated by the driving controller 200.

In addition, in an embodiment of the invention, a luminance difference due to a difference of the light emitting period between the immediately previous frame SF−1 of the sensing frame SF and the sensing frame SF may be compensated by the driving controller 200.

A length (e.g., between ET11 and ET12) of a non-emitting period between adjacent frames may be determined based on a horizontal period. In an embodiment, for example, the length of the non-emitting period may be four horizontal periods.

When one horizontal period is about 4.75 μs, the length (e.g., between ET11 and ET12) of the non-emitting period between the immediately previous frame SF−1 of the sensing frame SF and the sensing frame SF corresponding to the non-sensing area AR1 may be about 4.75 μs×4=about 19.0 μs.

In the first boundary BR1, the horizontal period may be changed from about 4.75 us to about 15 μs. Thus, the length of the non-emitting period of a first horizontal line of the sensing area AR2 may be about 4.75 μs×3+about 15 μs×1=about 29.25 μs. The length of the non-emitting period of a second horizontal line of the sensing area AR2 may be about 4.75 μs×2+about 15 μs×2=about 39.5 μs. The length of the non-emitting period of a third horizontal line of the sensing area AR2 may be about 4.75 μs×1+about 15 μs×3=about 49.75 μs. The lengths of the non-emitting period of a fourth horizontal line and next horizontal lines of the sensing area AR2 may be about 15 μs×4=about 60 μs.

In the second boundary BR2, the horizontal period may be changed from about 15 us to about 4.75 μs. Thus, the length of the non-emitting period of a first horizontal line of the second non-sensing area AR3 may be about 4.75 μs×1+about 15 μs×3=about 49.75 μs. The length of the non-emitting period of a second horizontal line of the second non-sensing area AR3 may be about 4.75 μs×2+about 15 μs×2=about 39.5 μs. The length of the non-emitting period of a third horizontal line of the second non-sensing area AR3 may be about 4.75 μs×3+about 15 μs×1=about 29.25 μs. The lengths of the non-emitting period of a fourth horizontal line and next horizontal lines of the second non-sensing area AR3 may be about 4.75 μs×4=about 19 μs.

In an embodiment of the invention, a luminance difference due to a change of the horizontal period at the first boundary BR1 and the second boundary BR2 may be compensated by the driving controller 200.

According to embodiments of the display apparatus and the method of driving the display apparatus, the sensing time may be reduced by setting the horizontal period of the normal frame and the horizontal period of the sensing frame differently from each other in the display apparatus including the display panel 100 including the light sensing circuit SN.

The length of the sensing frame may be set to twice the length of the normal frame and the first horizontal period of the sending frame corresponding to the non-sensing area AR1 and the second horizontal period of the sensing frame corresponding to the sensing area AR2 may be appropriately set such that the sensing operation may be completed within twice the time of the normal frame.

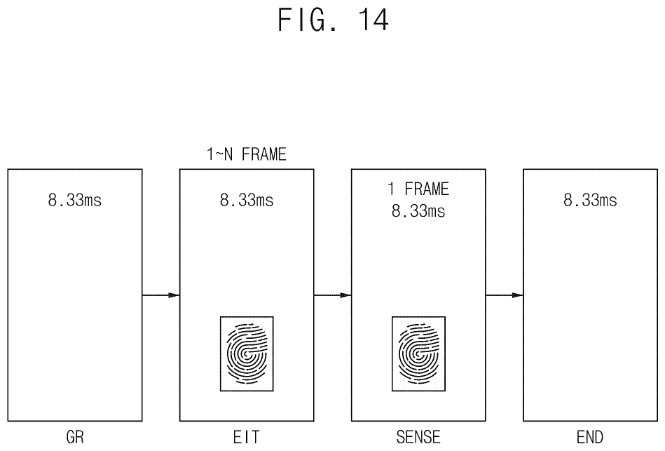

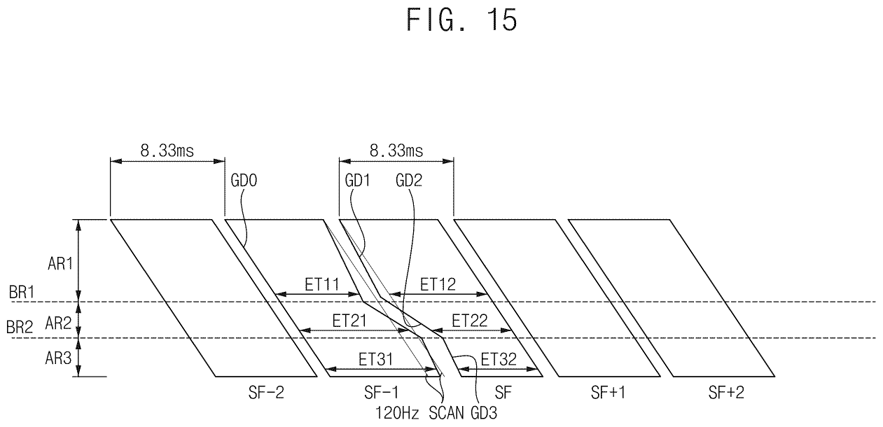

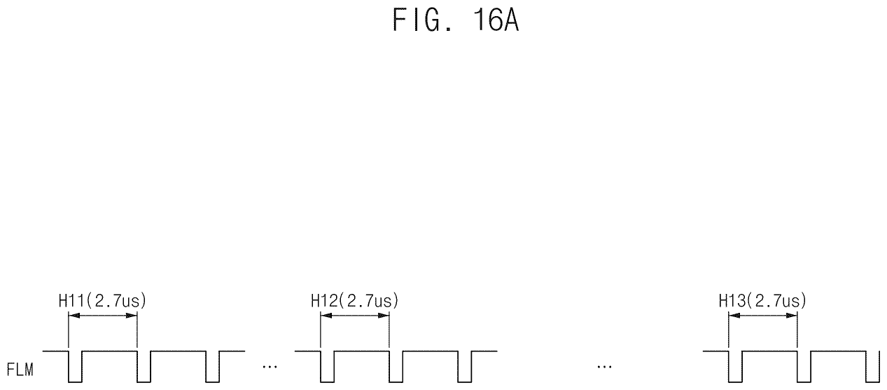

FIG. 14 is a diagram illustrating a sensing operation of the display apparatus of FIG. 1 when the length of the sensing frame is substantially the same as the length of the normal frame. FIG. 15 is a diagram illustrating a driving timing of the display apparatus of FIG. 1 when the length of the sensing frame is substantially the same as the length of the normal frame. FIG. 16A is a diagram illustrating a horizontal period of the normal frame of FIG. 15. FIG. 16B is a diagram illustrating a horizontal period of the sensing frame of FIG. 15.

The display apparatus and the method of driving the display apparatus according to an embodiment shown in FIGS. 14 to 16B are substantially the same as the display apparatus and the method of driving the display apparatus according to the embodiments described above with reference to FIGS. 1 to 13B except that the length of the sensing frame is substantially the same as the length of the normal frame. Thus, the same reference numerals will be used to refer to the same or like parts as those described above with reference to FIGS. 1 to 13B and any repetitive detailed description thereof will be omitted.

Referring to FIGS. 1 to 9, 11 and 14 to 16B, in an embodiment, for example, a driving frequency of the display panel 100 may be 120 Hz, and accordingly, the length of the normal frame may be about 8.33 ms. However, the invention may not be limited to the driving frequency of the display panel 100.

SENSE in FIG. 14 may mean the sensing operation SENSE of FIG. 8. In an embodiment, the length of the sensing frame in which the sensed signal is sensed from the light sensing circuit SN may be substantially the same as the length of the normal frame, in which the sensed signal is not sensed from the light sensing circuit SN. In an embodiment, for example, the length of the normal frame may be about 8.33 ms and the length of the sensing frame may be about 8.33 ms.

The horizontal period of the normal frame may be different from the horizontal period of the sensing frame.

In an embodiment, for example, the horizontal period of the sensing frame may include a first horizontal period corresponding to the non-sensing area AR1 of the display panel 100 and a second horizontal period corresponding to the sensing area AR2 of the display panel 100. The first horizontal period may be different from the second horizontal period.

In an embodiment, for example, the second horizontal period may be longer than the first horizontal period. The second horizontal period may be longer than the horizontal period (e.g., about 2.7 μs) of the normal frame. The second horizontal period may be about 12 us to about 15 μs.

When the total number of the pixel rows of the display panel 100 is denoted by M, a number of pixel rows in the sensing area AR2 is denoted by X, the length of the sensing frame is denoted by FRM, the second horizontal period is denoted by SH and the first horizontal period is denoted by NSH,

$$NSH = \frac{FRM - SH \times X}{M - X}$$

may be satisfied.

When the total number M of the pixel rows is 3080, the number of the pixel rows in the sensing area AR2 is 200, the length FRM of the sensing frame is about 8.33 ms and the second horizontal period SH is about 15 μs, the first horizontal period NSH may be about 1.85 μs.

The first horizontal period (e.g., about 1.85 μs) may be shorter than the horizontal period (e.g., about 2.7 μs) of the normal frame.

In FIG. 15, SF may be the sensing frame and SF−1 may be a frame immediately prior to the sensing frame SF. In FIG. 15, SF−2, SF+1 and SF+2 may be normal frames.

In FIG. 15, the horizontal period (e.g., about 2.7 μs) of the normal frame may be represented as a slope of GD0. In FIG. 15, the first horizontal period (e.g., about 1.85 μs) corresponding to the non-sensing area AR1 of the sensing frame may be represented as a slope of GD1. In FIG. 15, a third horizontal period (e.g., about 1.85 μs) corresponding to the second non-sensing area AR3 of the sensing frame may be represented as a slope of GD3.

In FIG. 15, the slope of GD1 (corresponding to the horizontal period of about 1.85 μs) may be greater than a slope (corresponding to a horizontal period of about 2.7 μs) of a scan timing of 120 Hz.

FIG. 16A illustrates the horizontal period H21 (e.g., about 2.7 μs) corresponding to the non-sensing area AR1 of the normal frame, the horizontal period H22 (e.g. about 2.7 μs) corresponding to the sensing area AR2 of the normal frame and the horizontal period H23 (e.g. about 2.7 μs) corresponding to the second non-sensing area AR3 of the normal frame.

FIG. 16B illustrates the horizontal period H21 (e.g. about 1.85 μs) corresponding to the non-sensing area AR1 of the sensing frame SF, the horizontal period H22 (e.g. about 15 μs) corresponding to the sensing area AR2 of the sensing frame SF and the horizontal period H23 (e.g. about 1.85 μs) corresponding to the second non-sensing area AR3 of the of the sensing frame SF.

Referring back to FIG. 15, in an embodiment where the non-sensing area AR1 and the sensing area AR2 are sequentially disposed along the scanning direction of the gate signal GW, a light emitting period ET12 of the non-sensing area AR1 may gradually increase along the scanning direction in the sensing frame SF and a light emitting period ET22 of the sensing area AR2 may gradually decrease along the scanning direction in the sensing frame SF. In such an embodiment, a light emitting period ET32 of the second non-sensing area AR3 may gradually increase along the scanning direction in the sensing frame SF.

A light emitting period of an immediately previous frame SF−1 of the sensing frame SF may be determined in relation to a light emitting period of the sensing frame SF. Thus, in an embodiment where the non-sensing area AR1 and the sensing area AR2 are sequentially disposed along the scanning direction of the gate signal GW, a light emitting period ET11 of the non-sensing area AR1 may gradually decrease along the scanning direction in the immediately previous frame SF−1 of the sensing frame SF and a light emitting period ET21 of the sensing area AR2 may gradually increase along the scanning direction in the immediately previous frame SF−1 of the sensing frame SF. In such an embodiment, a light emitting period ET31 of the second non-sensing area AR3 may gradually decrease along the scanning direction in the immediately previous frame SF−1 of the sensing frame SF.

In an embodiment of the invention, a luminance difference due to a difference of the light emitting period ET12, ET22 and ET32 between the non-sensing area AR1, the sensing area AR2 and the second non-sensing area AR3 in the sensing frame SF may be compensated by the driving controller 200.

In an embodiment of the invention, a luminance difference due to a difference of the light emitting period ET11, ET21 and ET31 between the non-sensing area AR1, the sensing area AR2 and the second non-sensing area AR3 in the immediately previous frame SF−1 of the sensing frame SF may be compensated by the driving controller 200.

In addition, in an embodiment of the invention, a luminance difference due to a difference of the light emitting period between the immediately previous frame SF−1 of the sensing frame SF and the sensing frame SF may be compensated by the driving controller 200.

In an embodiment of the invention, a luminance difference due to a change of the horizontal period at the first boundary BR1 and the second boundary BR2 may be compensated by the driving controller 200.

According to embodiments of the display apparatus and the method of driving the display apparatus, the sensing time may be reduced by setting the horizontal period of the normal frame and the horizontal period of the sensing frame differently from each other in the display apparatus including the display panel 100 including the light sensing circuit SN.

The length of the sensing frame may be set substantially the same as the length of the normal frame and the first horizontal period of the sending frame corresponding to the non-sensing area AR1 and the second horizontal period of the sensing frame corresponding to the sensing area AR2 may be appropriately set such that the sensing operation may be completed within substantially the same time as the normal frame.

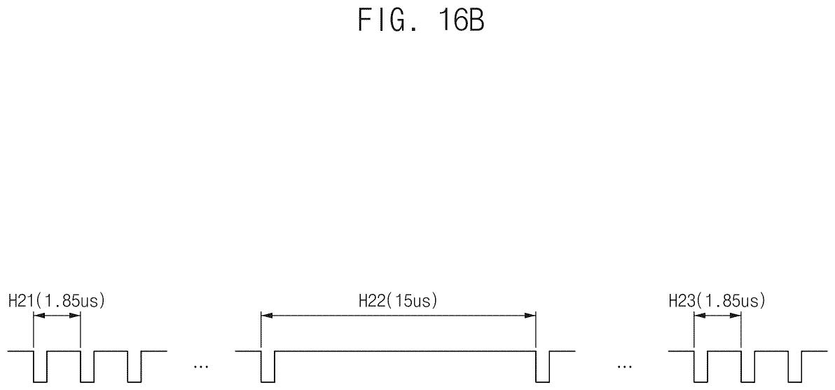

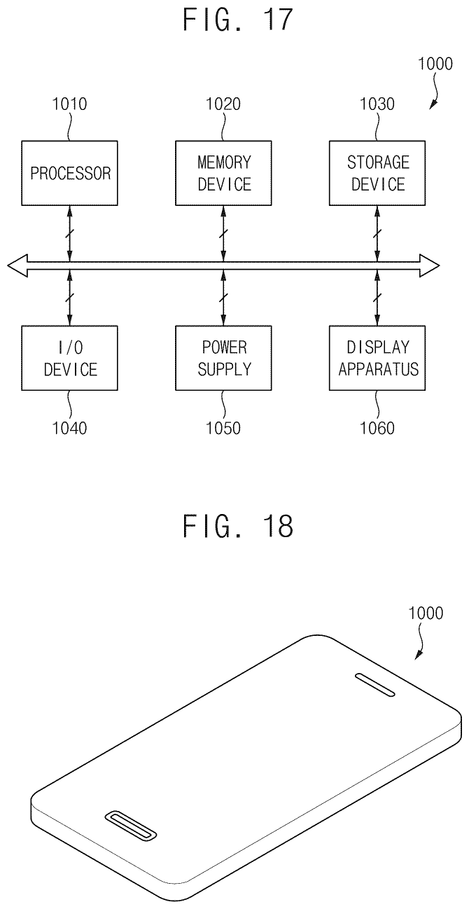

FIG. 17 is a block diagram illustrating an electronic apparatus 1000 according to an embodiment of the invention. FIG. 18 is a diagram illustrating an example in which the electronic apparatus 1000 of FIG. 17 is implemented as a smart phone.

Referring to FIGS. 1 to 18, an embodiment of the electronic apparatus 1000 may include a processor 1010, a memory device 1020, a storage device 1030, an input/output (I/O) device 1040, a power supply 1050 and a display apparatus 1060. Here, the display apparatus 1060 may be the display apparatus of FIG. 1. In an embodiment, the electronic apparatus 1000 may further include a plurality of ports for communicating with a video card, a sound card, a memory card, a universal serial bus (USB) device, other electronic apparatuses, etc.

In an embodiment, as illustrated in FIG. 18, the electronic apparatus 1000 may be implemented as a smart phone. However, the electronic apparatus 1000 is not limited thereto. In an embodiment, for example, the electronic apparatus 1000 may be implemented as a cellular phone, a video phone, a smart pad, a smart watch, a tablet computer, a car navigation system, a computer monitor, a laptop, a head mounted display (HMD) device, or the like.

The processor 1010 may perform various computing functions or various tasks. The processor 1010 may be a micro-processor, a central processing unit (CPU), an application processor (AP), or the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG and the input control signal CONT to the driving controller 200 of FIG. 1.

The memory device 1020 may store data for operations of the electronic apparatus 1000. In an embodiment, for example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, or the like and/or at least one volatile memory device such as a dynamic random access memory (DRAM) device, a static random access memory (SRAM) device, a mobile DRAM device, or the like.

The storage device 1030 may include a solid state drive (SSD) device, a hard disk drive (HDD) device, a CD-ROM device, or the like. The I/O device 1040 may include an input device such as a keyboard, a keypad, a mouse device, a touch-pad, a touch-screen, or the like and an output device such as a printer, a speaker, or the like. In some embodiments, the display apparatus 1060 may be included in the I/O device 1040. The power supply 1050 may provide power for operations of the electronic apparatus 1000. The display apparatus 1060 may be coupled to other components via the buses or other communication links.

In embodiments of the display apparatus, the method of the display apparatus and the electronic apparatus including the display apparatus according to the invention as described above, the sensing time may be reduced in the display apparatus including the display panel including the light emitting circuit.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A display apparatus comprising:
a display panel comprising a pixel circuit including a light emitting element and a light sensing circuit including a light sensing element;
a gate driver which outputs a gate signal to the pixel circuit and the light sensing circuit;
a data driver which outputs a data voltage to the pixel circuit; and
a sensing processor which receives a sensed signal from the light sensing circuit,
wherein a horizontal period of a normal frame, in which the sensed signal is not sensed from the light sensing circuit, is different from a horizontal period of a sensing frame in which the sensed signal is sensed from the light sensing circuit.

2. The display apparatus of claim 1, wherein the horizontal period of the sensing frame includes a first horizontal period corresponding to a non-sensing area of the display panel and a second horizontal period corresponding to a sensing area of the display panel, and
wherein the first horizontal period is different from the second horizontal period.

3. The display apparatus of claim 2, wherein the second horizontal period is longer than the first horizontal period.

4. The display apparatus of claim 2, wherein the second horizontal period is longer than the horizontal period of the normal frame.

5. The display apparatus of claim 2, wherein when a total number of pixel rows of the display panel is denoted by M, a number of pixel rows in the sensing area is denoted by X, a length of the sensing frame is denoted by FRM, the second horizontal period is denoted by SH and the first horizontal period is denoted by NSH, NSH=FRM−SH×X/M−X is satisfied.

6. The display apparatus of claim 2, wherein a length of the sensing frame is twice a length of the normal frame.

7. The display apparatus of claim 6, wherein the first horizontal period is longer than the horizontal period of the normal frame.

8. The display apparatus of claim 7, wherein the first horizontal period is shorter than twice the horizontal period of the normal frame.

9. The display apparatus of claim 6, wherein the non-sensing area and the sensing area are sequentially disposed along a scanning direction of the gate signal, and a light emitting period of the non-sensing area gradually decreases along the scanning direction in the sensing frame and a light emitting period of the sensing area gradually decreases along the scanning direction in the sensing frame.

10. The display apparatus of claim 9, wherein a light emitting period of the non-sensing area gradually increases along the scanning direction in an immediately previous frame of the sensing frame and a light emitting period of the sensing area gradually increases along the scanning direction in the immediately previous frame of the sensing frame.

11. The display apparatus of claim 2, wherein a length of the sensing frame is substantially the same as a length of the normal frame.

12. The display apparatus of claim 11, wherein the first horizontal period is shorter than the horizontal period of the normal frame.

13. The display apparatus of claim 11, wherein the non-sensing area and the sensing area are sequentially disposed along a scanning direction of the gate signal, and
a light emitting period of the non-sensing area gradually increases along the scanning direction in the sensing frame and a light emitting period of the sensing area gradually decreases along the scanning direction in the sensing frame.

14. The display apparatus of claim 13, wherein a light emitting period of the non-sensing area gradually decreases along the scanning direction in an immediately previous frame of the sensing frame and a light emitting period of the sensing area gradually increases along the scanning direction in the immediately previous frame of the sensing frame.

15. The display apparatus of claim 1, wherein the light sensing circuit further comprises:
an eighth transistor including a control electrode connected to a fourth node, a first electrode which receives a first voltage and a second electrode connected to a fifth node;
a ninth transistor including a control electrode which receives a reset signal, a first electrode which receives a reset voltage and a second electrode connected to the fourth node; and
a tenth transistor including a control electrode which receives the gate signal, a first electrode connected to the fifth node and a second electrode connected to a sensing line, and
wherein the light sensing element includes a first electrode connected to the fourth node and a second electrode which receives a second power voltage.

16. The display apparatus of claim 15, wherein the pixel circuit further comprises:
a first transistor including a control electrode connected to a first node, a first electrode connected to a second node and a second electrode connected to a third node;
a second transistor including a control electrode which receives the gate signal, a first electrode which receives the data voltage and a second electrode connected to the second node;
a third transistor including a control electrode which receives a compensation gate signal, a first electrode connected to the first node and a second electrode connected to the third node;
a fourth transistor including a control electrode which receives a data initialization gate signal, a first electrode which receives a first initialization voltage and a second electrode connected to the first node;
a fifth transistor including a control electrode which receives an emission signal, a first electrode which receives a first power voltage and a second electrode connected to the second node;
a sixth transistor including a control electrode which receives the emission signal, a first electrode connected to the third node and a second electrode connected to a first electrode of the light emitting element; and
a seventh transistor including a control electrode which receives a light emitting element initialization gate signal, a first electrode which receives a second initialization voltage and a second electrode connected to the first electrode of the light emitting element, and
wherein a second electrode of the light emitting element receives the second power voltage.

17. The display apparatus of claim 15, wherein the sensing processor comprises:
an amplifier including a first input terminal connected to the sensing line, a second input terminal which receives a reference voltage and an output terminal;
a first switch connected between the first input terminal of the amplifier and the output terminal of the amplifier;
a first capacitor connected between the first input terminal of the amplifier and the output terminal of the amplifier;
an analog-to-digital converter including a first input node and a second input node;
a second switch connected between the output terminal of the amplifier and the first input node of the analog-to-digital converter; and
a third switch connected between the output terminal of the amplifier and the second input node of the analog-to-digital converter.

18. A method of driving a display apparatus, the method comprising:
outputting a gate signal to a pixel circuit including a light emitting element and a light sensing circuit including a light sensing element;
outputting a data voltage to the pixel circuit; and
receiving a sensed signal from the light sensing circuit,
wherein a horizontal period of a normal frame, in which the sensed signal is not sensed from the light sensing circuit, is different from a horizontal period of a sensing frame in which the sensed signal is sensed from the light sensing circuit.

19. The method of claim 18, wherein the horizontal period of the sensing frame includes a first horizontal period corresponding to a non-sensing area of a display panel and a second horizontal period corresponding to a sensing area of the display panel, wherein the first horizontal period is different from the second horizontal period, and wherein when a total number of pixel rows of the display panel is denoted by M, a number of pixel rows in the sensing area is denoted by X, a length of the sensing frame is denoted by FRM, the second horizontal period is denoted by SH and the first horizontal period is denoted by NSH,
$$NSH = \frac{FRM - SH \times X}{M - X}$$
is satisfied.

20. An electronic apparatus comprising:
a display panel comprising a pixel circuit including a light emitting element and a light sensing circuit including a light sensing element;
a gate driver which outputs a gate signal to the pixel circuit and the light sensing circuit;
a data driver which outputs a data voltage to the pixel circuit;
a sensing processor which receives a sensed signal from the light sensing circuit;
a driving controller which controls the gate driver, the data driver and the sensing processor; and
a processor which outputs input image data and an input control signal to the driving controller,
wherein a horizontal period of a normal frame, in which the sensed signal is not sensed from the light sensing circuit, is different from a horizontal period of a sensing frame in which the sensed signal is sensed from the light sensing circuit.
